(19) United States
(12) Patent Application Publication
(10) Pub. No.: US 2016/0026954 A1
(43) Pub. Date: Jan. 28, 2016

(54) SYSTEM AND METHOD OF LEGAL PROJECT MANAGEMENT

(71) Applicant: Y FIRM MANAGEMENT INC., Toronto, Ontario (CA)

(72) Inventor: Howard Brian BORLACK, Toronto (CA)

(21) Appl. No.: 14/777,093

(22) PCT Filed: Mar. 15, 2013
(86) PCT No.: PCT/CA2013/000244

§ 371 Date: Sep. 15, 2015

(51) Int. Cl. G06Q 10/06; G06Q 50/18

(52) U.S. Cl. CPC G06Q 10/06313; G06Q 50/18

(57) ABSTRACT

A system and method for managing legal projects and cases is provided. Case data is received and maintained in the system. The data is structured to allow proper a assignment of data entry tasks to appropriate accounts. The structuring is based on stages of the case which allows monitoring case or project progress as well. Moreover, interfaces are provided to further facilitate the data entry structuring. To properly structure the data entry tasks, the system maintains case data including accounts for each case manager, facts data related to the case, parties data representing the different parties, and status data identifying the different stages available to the case. Meta data is also maintained to allow collecting metrics regarding the case quality of project management.

### BACKGROUND OF THE INVENTION

1. Field of the Invention

The present invention is directed to project management systems in general and legal case management systems specifically.

2. Description of the Related Art

Typically, legal case management involves different types of services provided by law firms. Accordingly, a client approaches a law firm with a legal service requirement. The legal service can be an accident benefit claim, a civil litigation, contract drafting or others. Each case involves at least one lawyer and potentially assistants, clerks and other paralegals. Moreover, a case can involve another party such as an opposing party in the case of litigation whose interest oppose the client's interests. Cases also involve third parties such as actuators mediators, courts and others who assist with the progress of the case at various stages. Managing a case to completion involves gathering and tracking large amounts data, dates and other information, analyzing that data and distilling the portions relevant to the case. For example, documents are gathered and analyzed to assess injury, due dates are tracked to ensure timely progress of the case through mediation, settlement talks and courts, and costs are tracked to ensure fair results to a client.

### SUMMARY OF THE INVENTION

It is an aspect to provide a computing device for legal project management. The device can comprise:

a datastore configured for:
storing a plurality of accounts; and
storing case data for a case including a current stage and a first association to a first account of the plurality of accounts; and

a processor configured for:

retrieving the current stage and the first account;

receiving entered data wherein the entry is performed by the first account.

The processor can be further configured for:

determining a next stage based on the entered data and the case data; and

determining a second account of the plurality of accounts based on the additional data and the case data.

The processor can be further configured for:

determining a ranking of the case based on the additional data;

determining a categorization of the second account; and

associating the second account with the case data based on said ranking and categorization.

The computing device can further comprise a network interface, and the processor can be further configured for:

sending an indication the data entry area for display at a client terminal.

The processor can be further configured for:

determining a workflow associated with the stage;

providing a an indication of a status bar indicating the current stage; and

providing an indication of a second status bar indicating the workflow.

It is a further aspect to provide a method for legal project management, performed on a computing device. The method can comprise:

maintaining a plurality of accounts

maintaining case data for a case including a current stage and a first association to a first account of the plurality of accounts;

providing a data entry area based on the current stage wherein the data entry area is for operation by the first account.

The method can further comprise:

receiving additional data;

determining a next stage based on the additional data and the case data; and

determining a second account of the plurality of accounts based on the additional data and the case data.

The determining a second account can further comprise:

determining a ranking of the case based on the additional data;

determining a categorization of the second account; and

associating the second account with the case data based on said ranking and categorization.

The providing can further comprise:

determining a workflow associated with the stage; and

updating the data entry are and the first account based on the workflow.

The method can further comprise:

providing a second data entry area based on the next stage wherein the second data entry area is for operation by the second account.

The case data can include a second association with a second account, and the data entry area can be additionally for operation by the second account.

The providing can further comprise

providing a status bar indicating the current stage; and

providing an indication of the entry area associated with the current stage.

The method can further comprise:

providing a plurality of selectors for selecting data entry areas; and

indicating at least one of the selectors as an indication of the entry area associated with the current stage.

The case ranking can be an indication of one of injury, claim amount, subject matter and complexity. The account categorization can be an indication of one of workload, availability, performance, seniority and subject matter expertise.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a block diagram of an aspect of a system for legal project management;

FIG. 2 shows a block diagram of case data in accordance with an aspect;

FIG. 3 shows a user interface in accordance with an aspect;

FIG. 4 shows a flow chart showing a method of legal project management in accordance with an aspect; and

FIG. 5 a user interface in accordance with an aspect.

### DETAILED DESCRIPTION OF THE PREFERRED EMBODIMENTS

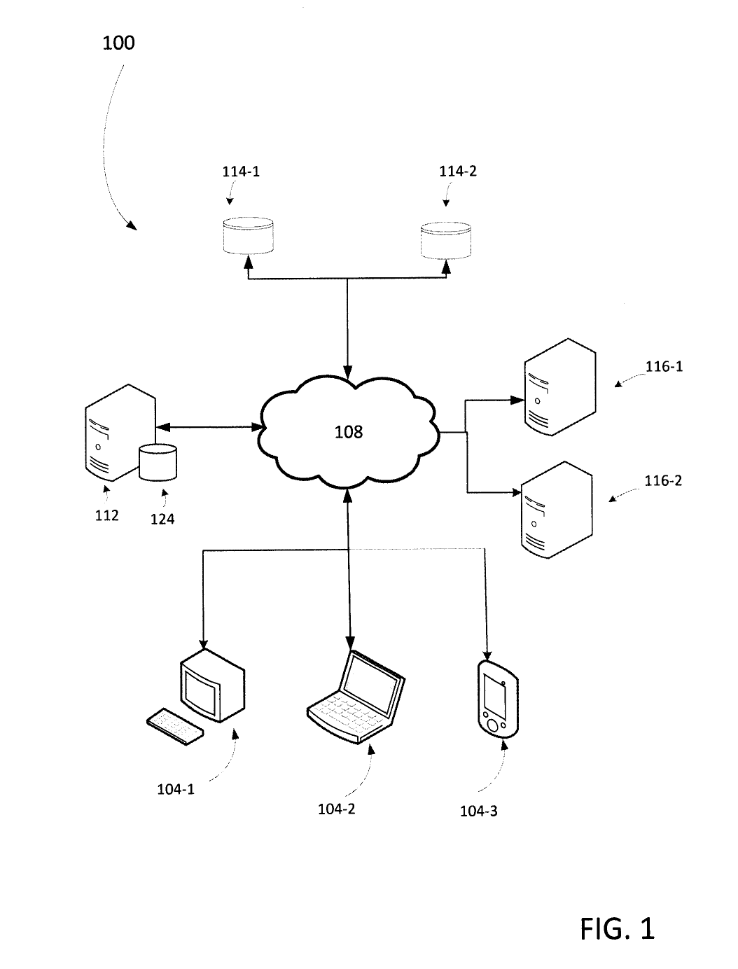

FIG. 1 shows a diagram of a system 100 for legal project management. At least one client terminal (client terminals 104-1, 104-2 and 104-3) is connected, via network 108, to server 112. Collectively, client terminals 104-1, 104-2 and 104-3 are referred to as client terminals 104, and generically as client terminal 104. This nomenclature is used elsewhere herein. Additionally, server 112 can also access at least one third party server 116 (third party servers 116-1 and 116-2) through network 108. Collectively, third party servers 116-1 and 116-2 are referred to as third party servers 116, and generically as third party server 116. This nomenclature is used elsewhere herein. Server 112, third party servers 116 and client terminals 104 can also access at least one cloud based storage 114 (cloud based storage 114-1, and 114-3) through network 108. Collectively, cloud based storage 114-1 and 114-2 are referred to as cloud based storage 114, and generically as cloud based storage 114. This nomenclature is used elsewhere herein.

Client terminals 104 can be based on any suitable computing environment, and the type is not particularly limited so long as each client terminal 104 is capable of receiving data from legal server 112, displaying data and transmitting data to legal server 112. In a present embodiment, client terminals 104 are configured to at least execute a web browser that can interact with the services hosted by legal server 112. In other embodiments other applications can be hosted and executed by terminal 104 that can interact with legal server 112.

Client terminals 104 can be based on any type of client computing environment, such as a desktop computer, a laptop computer, a netbook, a tablet, a smartphone, other mobile computing device or any other platform suitable for information processing that is known in the art. Each client terminal 104 includes at least one processor connected to a non-transitory computer readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one embodiment, memory includes both a non-volatile memory for persistent storage computer-readable instructions and other data, and a non-volatile memory for short-term storage of such computer-readable instructions and other data during the execution of the computer-readable instructions. Other types of computer readable storage medium external to client terminal 104 are also contemplated, such as secure digital (SD) cards and variants thereof. Other examples of external computer readable storage media include compact discs (CD-ROM, CD-RW) and digital video discs (DVD).

Client terminal 104 can also include one or more input devices connected to at least one processor. Such input devices are configured to receive input and provide data representative of such input to the processor. Input devices can include, for example, a keypad and a pointing device. A pointing device can be implemented as a computer mouse, track ball, track wheel, touchscreen or any suitable combination thereof. In some examples, client terminal 104 can include additional input devices in the form of one or more additional buttons, light sensors, microphones and the like. More generally, any suitable combination of the above-mentioned input devices can be incorporated into client terminal 104.

Client terminal 104 further includes one or more output devices. The output device s of client terminal 104 can include speakers, haptic feedback devices and others. The output devices of client terminal 104 can also include a display. When the pointing device includes a touchscreen, the touchscreen can be integrated with the display. Each client terminal 104 also includes a communications interface connected to the processor. The communications interface allows client terminal 104 to communicate with other computing devices, for example via network 108. The communications interface is therefore selected for compatibility with network 108.

Network 108 can comprise any network capable of linking legal server 112 with client terminals 104 and can include any suitable combination of wired and/or wireless networks, including but not limited to a Wide Area Network (WAN) such as the Internet, a Local Area Network (LAN), cell phone networks, Wi-Fi networks, WiMax networks and the like.

In general terms, legal server 112 can comprise any platform capable of processing, transmitting, receiving, and storing data. In a present embodiment, legal server 112 is a server configured for data-store management and processing in general and for contact data discovery specifically. Legal server 112 can be based on any desired server-type computing environment including appropriate configurations of one or more central processing units (CPUs) configured to control and interact with non-transitory computer readable media in the form of computer memory or a storage device. Computer memory or storage device can include volatile memory such as Random Access Memory (RAM), and non-volatile memory such as hard disk drives or FLASH drives, or a Redundant Array of Inexpensive Disks (RAID) or cloud-based storage 114. Legal server 112 also includes one or more network interfaces, to connect to network 108 or client terminal 104. Legal server 112 can also be configured to include input devices such as a keyboard or pointing device or output devices such as a monitor or a display or any of or all of them, to permit local interaction. Other types of hardware configurations for Legal server 112 are contemplated. For example, Legal server 112 can also be implemented as part of a cloud-based computing solution, whereby the functionality of Legal server 112 is implemented as one or more virtual machines executing at a single data center or in a mirrored form across a plurality of data centers. The software aspect of the computing environment of legal server 112 can also include remote access capabilities in lieu of, or in addition to, any local input devices or local output devices. Any desired or suitable operating system can be used in the computing environment of legal server 112. The computing environment can be accordingly configured with appropriate operating systems and applications to effect the functionality discussed herein. Those of skill in the art will now recognize that legal server 112 need not necessarily be implemented as a stand-alone device and can be integrated as part of a multi-purpose server or implemented entirely in software, for example a virtual machine. In a present embodiment, legal server 112 is connected to a storage device, such as a hard-disk drive, solid state drive, or any other type and arrangement of non-volatile storage device.

Continuing with FIG. 1, third party servers 116 are also shown. Third party servers 116 can comprise any platform capable of processing, transmitting, receiving, and storing data. In a present embodiment, third party servers 116 are configured to host third party services such as on-line stores, web sites, directory services or other information aggregation sites, social networking services, communications services and others. FIG. 1 shows third party server 116 to be linked to legal server 112 through network 108, although other variations in connectivity, such as links through a network separate or different from 108 and connections through proxies and gateways is contemplated and are within scope.

In the present embodiment third party servers 116 include third party data-stores. Third party data stored can be maintained on non-volatile memory such as hard disk drives or FLASH drives, or a Redundant Array of Inexpensive Disks (RAID) or cloud-based storage 114. Third party servers are typically used for, in addition to other functionality, storing or maintaining project data such as names, locations, types of clients such as individuals, groups, businesses and other organizations, occupation, type of business, service, claim information, court information, regulatory information and others. In the case of web sites, directories and other third party services, third party servers can include case related data such as court documents, insurance documents and information and others that will now occur to a person of skill in the art. Third party servers 116 can generally perform the functions of maintaining and providing data relevant to a case, and in particular specialized data such as those pertaining to actuary functions, a court, an insurance claim and others. A third party server 116 can however access one or more other third party servers 116 or other computing devices, to access other third party services such as search sites and other information aggregators and others to perform one or more of its functions.

In the present embodiment, legal server 112 maintains a project data-store 124. Project data-store 124 can be maintained on a storage device integral to or attached to legal server 112, or can be maintained at a remote storage facility such as a network connected storage device of at cloud storage or a combination of these storage options can be used. Broadly speaking, project data-store 124 is any data-store containing project data related to maintenance and management of one or more legal cases such as tort cases, accident benefit cases, and others.

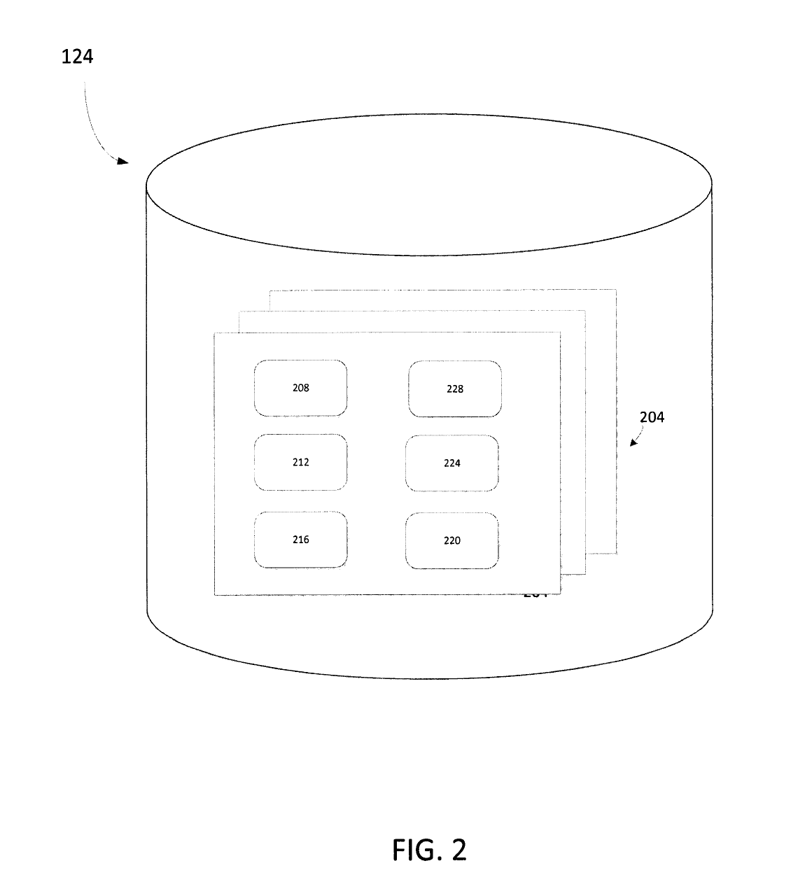

Referring now to FIG. 2, contents of the project data-store 124 is indicated as a block diagram. Included in data-store 124, project data 120 can be operated on to maintain and track a legal case. Project data-store 124 generally contains case data 204 for each case maintained within project data-store 124. Case data 204 includes parties data 208 representative of the parties involved in the case including the client, opposing party, third parties such as mediators, judges and others. Case data 204 further includes case manager data 212 which includes client lawyers, client clerks, client administrators, actuators and others assigned to the case to manage the case on behalf of the client. Case data 204 can further include opposing manager data 216 representing opposing managers such as lawyers, clerks and administrators managing the case for the opposing side. Case data 204 can also include status data 220. Status data typically pertains to how far along the case is in terms of its progress towards a final disposition. Status data 220 typically includes information regarding stages available to a case such as intake, mediation or closed, an indication of the particular stage the case is at, as well as status data for each stage such as in-progress, completed or next. The status data 220 can also include additional workflows associated with one or more of the stages, the workflows including one or more steps to be performed by an account. Case data 204 can also include facts data 224 representing the facts of the case. Facts data 224 can include data pertinent to the substantive management of the case such as injury type, potential claims, facts supporting the claims and others that will now occur to a person of skill in the art. The facts data 224 can also include data in the form of scans, communications, photos and other documents that will now occur to a person of skill in the art. Case data 204 can also include a case type data 228 which indicates the type of legal proceedings the particular case belongs to such as accident benefits, civil litigation and others that will now occur to a person of skill in the art. In an implementation, the case type data can be used to determine the extent of the content of the case data 204 for that case. For example, if case type is accident benefits, case data 204 would also include a mediation stage and the data associated with that stage, whereas, other case types may not allow for mediation, and thus data relating to mediation may be excluded.

Operating on the case data 204 can allow the collection of meta-data 232 which can be included as part of data-store 124. In one variation, metrics can be generated based on meta-data 232 regarding time and costs. To facilitate the collection of meta-data 232 and generation of metrics, additional data can be associated with the case data 204. For example, dates can be associated with the start and end of each stage. Billable hours can be tracked for each stage through the provision of timers. Other methods of generating meta-data 132 will now occur to a person of skill in the art.

Collected meta-data 232 can be used to assist the maintenance of a case. For example, alarms or notices can be generated if meta-data 232 indicates that the time cost of completing a given stage of a case is exceeding a pre-determined threshold. Meta-data 232 can also allow tracking whether legal requirements are appropriately being satisfied for a case by, for example, allowing the tracking of court maintained due dates and allowing the generation of due date notifications for a given stage of a case.

Meta-data 232 can also be used for analysis of a case during and after it is closed or while it is active. For example, metrics can be generated about the performance of each stage such as the time period it took to progress through case intake, the lawyer's cost of going through mediation, how long it took to move a case from a completed stage to the next stage. Metrics can also be generated for individual actions such as timing of key data received from other sources, initial assessment of expected claims versus final results, adjuster's performance and others that will now occur to a person of skill in the art. Metrics can also be generated for multiple cases such that cases can be compared to averages. Accordingly, metrics can be maintained for the firm that operates server 112, the client and other parties and entities that are included within system 100. Other uses for meta-data 232 will now occur to a person of skill in the art.

Cases contained within data-store 124 can be maintained and tracked through user interfaces provide by server 112 and that can be accessed by a client terminal 104. The access to server 112, and thus the user interfaces for case management can be accomplished through a web browser executing on a client terminal 104. In variations, the access can be achieved through other applications, such as a dedicated application available on client terminal 104. The browser or the applications can access the server 112 through web services or APIs provide by the server 112.

At least portion of the case data 204 for a case can be obtained from third party servers 116. For example, court documents and docket dates can be obtained from third party servers 116 maintained by the courts. Other information can be obtained from third party servers operated by regulators such as auto insurance regulators. The other information can be obtained through third part servers operated by the opposing parties, other law firms and others that will now occur to a person of skill in the art.

Data-store 124 and the case data 204 contained therein can be implemented using a variety of constructs including linked lists, arrays, object oriented containers, relational or flat databases, or recursive data structures amongst others. Moreover, although in this embodiment, the case data has been stored in a single data-store 124, in other variations, the data may be stored in more data-stores or other structures organized in a different manner. Furthermore, in other variations case data can be organized not along the types of data stored, but along other organizational characteristics. Variations in the implementation of data-store 124 and the case data 204 will now occur to one of skill in the art, all of which are contemplated as possible implementations of data storage and are considered within scope.

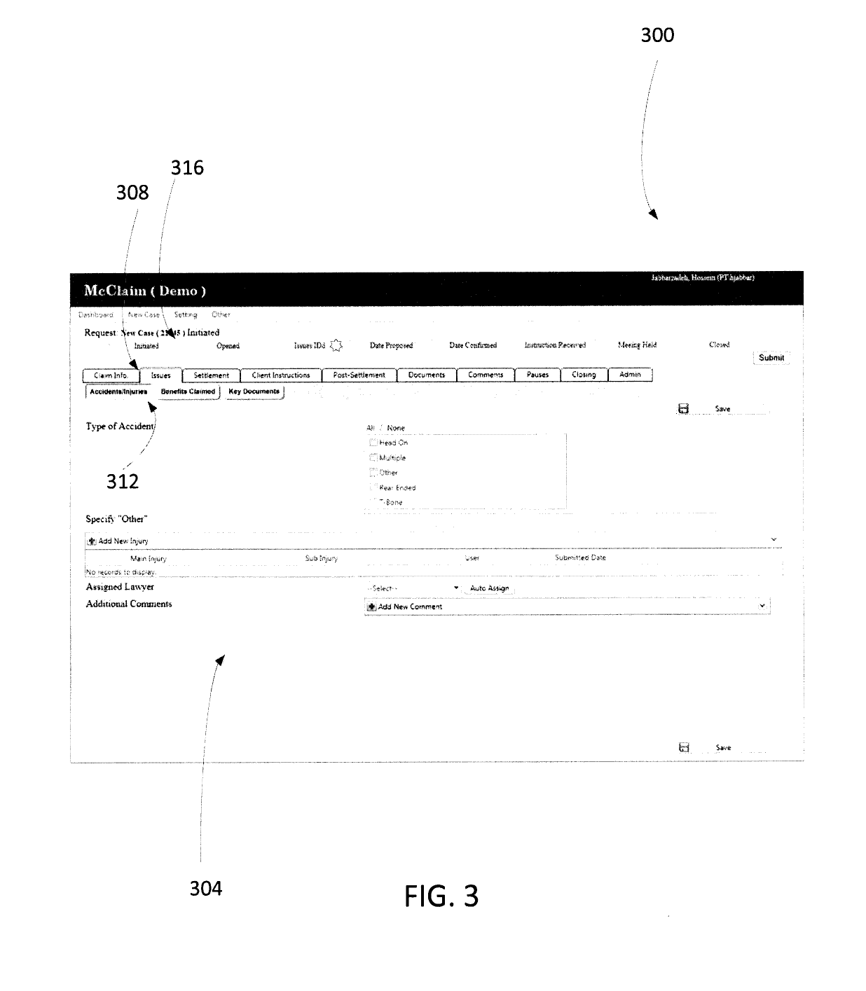

Referring to FIG. 3 and exemplary user interface is indicated at 300. It is to be understood that example user interface 300 is shown merely as an illustrative example and for the purposes of explaining various implementations. In one implementation server 112 generates indication for the interface which is communicated to client terminals 104 for display. The user interface 300 includes multiple different data entry areas 304. Data entry areas 304 allow entry of data that is to be contained within case data 204 and can include text boxes, lists, check boxes and other data entry items and methods that will now occur to a person of skill in the art that can provide for the entry of casa related data. Different data entry areas 304 can be accessed by selecting the appropriate data entry selector 308. Moreover, various mechanisms such as highlighting can be used for indicating the data entry area currently selected. For example, the highlighted data entry selector 308 in the example interface 300 indicates that the data entry area related to “Issues” is currently operational. Data entry areas 304 can further include sub data entry areas within a data entry area 304. The sub data entry areas can be selected and by secondary selectors 312. In some implementations, a sub data entry area is only visible when selected. As an example, in FIG. 3, the depressed secondary selector 312 indicates that sub data entry area “Accidents/Injuries” is currently selected.

Continuing with FIG. 3, at 316 a case stage status bar is indicated at 316. Status bar 316 indicates at least a subset of stages available to a case, arranged, in order of progression, from left to right. Accordingly, the example case indicated at user interface 300 includes the stages: Initiated whrer the case is initiated, for example by a client; opened, where the case is opened by a clerk; Issued IDd, where the issues are identified by a case clerk on the basis of data and documents obtained; Date Proposed, where a settlement meeting date is proposed, Date Confirmed, where the date is confirmed by all parties; Instructions Received, where client instructions for settlement are received by the case lawyer, for example; Meeting Held, which summarizes the result of the meeting; and Closed, where the case reaches a final disposition.

Referring to FIG. 3, the user interface 300 can include additional indicators indicating the current stage of the case. For example, the example user interface 300 includes a star on the indicator for the stage Issues IDd indicating that the example case is at the stage Issues IDd. In some implementations, indication of a current stage would also indicate that the stages previous to it, such as those to the left of it in status bar 316, are completed. In variations, the relevant data areas for a given stage can be indicated by, for example, highlighting the relevant data entry selector 308. Accordingly, in FIG. 3, the data area 304 for Issues is indicated to be relevant data area for Issues IDd stage. In variations, the highlighting to indicate data area relevant for a stage can be different than the highlighting that indicates the selected data entry area. It will now occur to a person of skill in the art that other methods of highlighting the selectors 308, 312 and the row 316 are available and are contemplated. In other variations, selection of a stage by selecting a portion of the row 16 corresponding to a stage can automatically present the appropriate data entry area for that stage. Moreover, in further variations, when the user interface 300 is brought up for a newly selected case, it can automatically provide the data area appropriate for the stage the newly selected case is currently at.

Provisioning of a status bar 316 and establishing links between the stages indicated by the status bar 316 and data entry areas/data entry selectors can allow for efficient organization and management of a case workflow and its large amount of data using a limited display size. This advantage can be particularly relevant for client terminals 104 with small display sizes such as smartphones and tablets. This advantage can also carry over to efficient organization of data for legal case management. For example, in variations case data 204 can be organized in data-store 124 on the basis data entry areas increasing the efficiency in retrieving data for presentation in the user interface and storing data obtained through the user interface.

In some implementations, each stage can include multiple workflow steps. Accordingly, the account associated with a data entry area can be altered on the bases of the steps of the workflow. Moreover, the area can be varied depending on the workflow step. In other implementations, different data entry areas can be associated with each stage depending on the workflow step. In further variations, the workflow can be displayed as a secondary status bar indicating steps to be performed. In these variations, indications can be provided for links between the workflow step and the data entry areas. It will now occur to a person of skill in the art that other variations of account stage workflow and data entry area are possible.

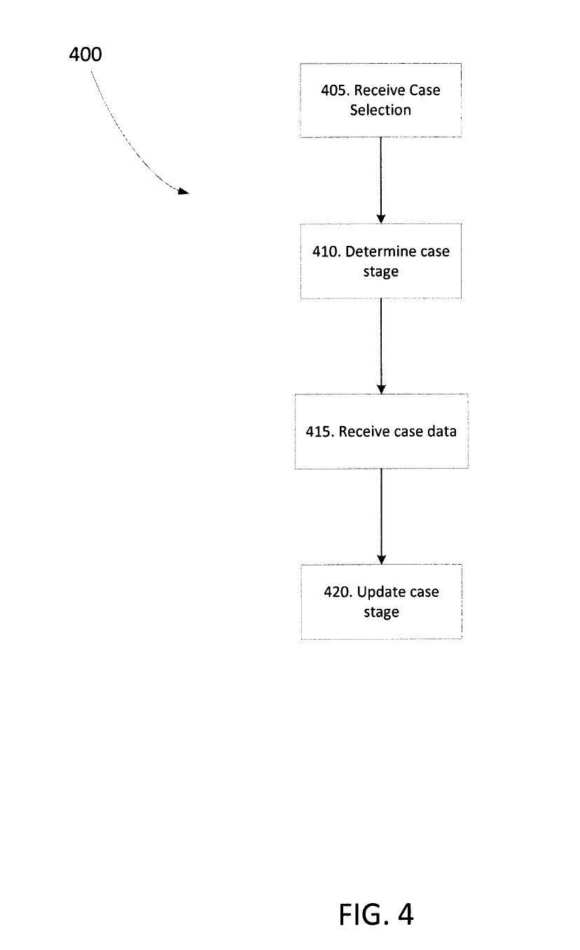

Referring now to FIG. 4, a method of legal case management is indicated generally at 400. In order to assist in the explanation of the method, it'll be assumed that method 400 is operated using system 100 as shown in FIG. 1. Additionally, the following discussion of method 400 leads to further understanding of system 100. However, it is to be understood that system 100, and method 400 can be varied, and need not work exactly as discussed herein in conjunction with each other, and that such variations are within scope.

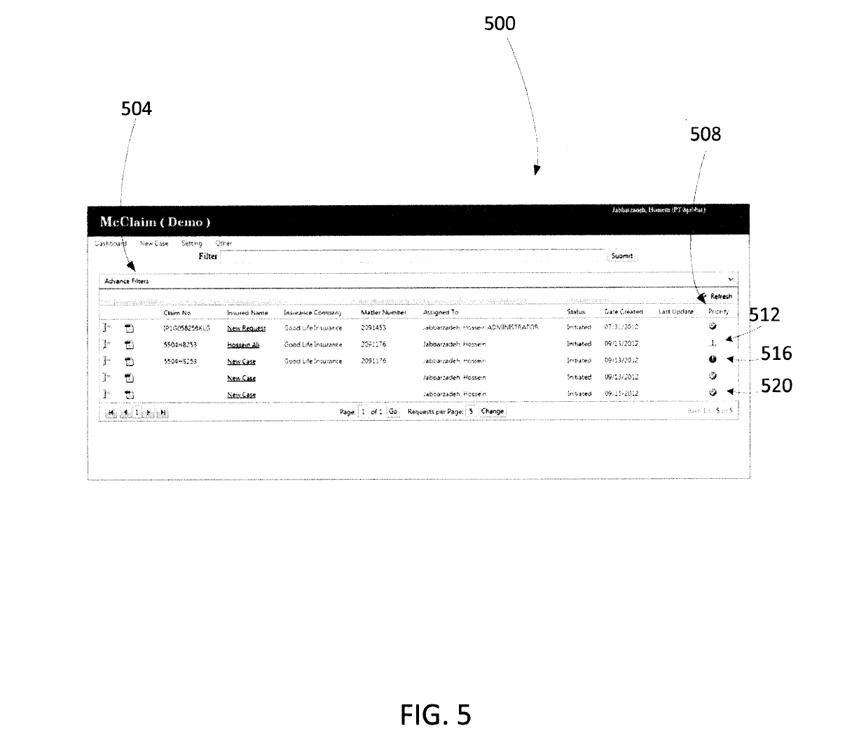

Beginning first at 405, a case selection is received. Typically, data-store 128 maintains case data 204 for a number of different cases. Server 112 can provide various user interfaces for selecting a case for processing. Referring to FIG. 5, an example dashboard interface is indicated at 500. The case list 504 is at least a partial list of cases maintained in data-store 124 for processing by server 112. In one implementation, the cases listed can be determined on the basis of the account accessing the server 112. For example, if a clerk “Zoya” is accessing server 112 through her account, then the cases listed can be those cases which include “Zoya”'s account as part of the case manager data 208 for that case. Alternatively, if a lawyer “Cindy” is accessing server 112 through her account, then the cases listed can be those cases which include “Cindy” as part of the case manager data 208 for that case. There are other methods for filtering data based on account and other criteria that will now occur to a person of skill in the art. It'll be assumed that the account accessing server 112 is clerk “Zoya”. The case list 504 allows the selection of a case for further processing. Accordingly, “Zoya” can choose through the input devices attached to her client terminal 104 one of the cases listed for further processing.

Accounts can be associated with a case through various means. For example, accounts belonging to clerks, lawyers and other personnel managing a client's case can be case managers for that case and maintained as part of the case manager data 212 for that case. Supervisor accounts can be associated with all or a selected list of cases to monitor the progress of lawyers and clerks, and also be stored as part of the case manager data 212. Client accounts, third party account and other accounts can also be associated with a case. The amount of case data visible to an account can be based on the type of account. Other mechanisms of associating accounts with cases will now occur to a person of skill in the art.

In some implementations, accounts can have types such as a lawyer, a clerk, an administrator, a manager, a client, and actuator and others that will now occur to a person of skill in the art. Furthermore, accounts can also have additional classification criteria. For example, lawyer accounts can be classified as junior, senior, supervising. Similarly, clerk accounts can be classified as junior or senior. In addition, accounts can have expertise categories, such as bodily injury, water tank subrogation, and others that will now occur to a person of skill in the art.

In some implementations, a client account can be provided access to monitor cases associated with that client. In these implementations, reporting to the client can take the form of dashboard or other data entry or presentation areas where case status and stage is updated and brought to the attention of the client.

In variations, the server 112 can receive instructions data from a client account for performing certain tasks such as entering a settlement. This instruction can be maintained as part of the case data 202 and relied upon for performing future tasks without obtaining additional instructions from the client as long as the instruction criteria are satisfied. For example, the client could provide a settlement authority for a certainamount of business. Accordingly, the lawyers the ability to settle a file quickly when speaking with the claimants rep without having to go back to our client to seek instructions providing the offer falls within the settlement criteria such as the authority amount. The dashboard 500 can also be used for monitoring cases maintained by data-store 124. For example, the list 504, in addition to including identifying information for each case such as claim number, matter number and insured name, can also include indicators for information based on meta-data 232. For example, priority column 508 provides information regarding timing priority of a case. Accordingly, in one implementation, the cases can be indicated as heightened priority 512 (exclamation mark within a triangle) if the duration of the cases current stage as determined on the basis of meta-data 232 is approaching an average duration for that stage as determined on the bases of meta-data metrics across a number of cases of similar type. Furthermore, the cases can be indicated as urgent priority 516 (exclamation mark within a circle) if the duration of the cases current stage as determined on the basis of meta-data 232 has exceeded, by a pre-determined amount an average duration for that stage as determined on the bases of meta-data metrics across a number of cases of similar type. Otherwise the cases can be indicated as normal priority 520 (checkmark). The list 504 can also include information and metrics for each case based on approaching due dates, costs, responsiveness of clients or opposing parties and other information based on meta-data 232 such as alarms and notices that will now occur to a person of skill in the art.

Referring back to FIG. 4 and continuing with method 400, once a case is selected current project status is received at 410. In this example implementation, the current project status is received from case-data 204 for the selected case, for example, by querying data-store 124 for status data 220. It'll be assumed that the current stage for the selected case is Issues IDd. Accordingly, a user interface will be presented to facilitate managing that particular case. In this example implementation, it'll be assumed that the user interface 300, as shown in FIG. 3 and described above, is presented based on the current stage of the case.

Continuing with method 400, data is received pertaining to the case at 415. Current stage data is typically entered through data entry area 304. Typically, each case requires the accumulation of large amounts of data. Entry of the data in an unstructured manner can lead to delayed, missed or inaccurate data. Moreover, it becomes difficult to determine whether different requirements and metrics are satisfied in a timely manner. In one implementation, each stage or workflow step can be appropriately structured such that the data entry can be separated for each stage. This allows for determining satisfaction of requirements for each stage with greater accuracy. For example, the timeliness, associated costs, requisite deadlines and other requirements can be more readily tracked for each stage, since the data needed to make these determinations are structured to be entered together, such as facts data 224, parties data 208 and others that will now occur to a person of skill in the art.

In one implementation, the data entry structuring can be accomplished through the use of a user interface. As discussed above in light of FIG. 3, in variations, the relevant data areas for a given stage or workflow step can be indicated by, for example, highlighting the relevant data entry selector 308. Accordingly, the data area for a stage can be indicated to be a relevant data area for that stage. Furthermore, sub data entry areas, accessible through secondary selectors can be provided to allow sub categorizing of a data area.

Moreover, in some implementations, the stages or workflows contained therein can be structured such that the data entry and actions associated with that stage can performed by one account type. For example, the example stage Issue IDd can be structured such that the requisite data entry and actions to complete that stage can be performed by an account of type clerk. On the other hand the client instructions stage, for example, can be structured such that the data entry and actions for that stage can be primarily performed by a lawyer account type. Sub-categorization can be used where more than one account type is involved at a stage, allowing the stage activity to be divided as a sub-category per each account type as per workflow steps.

Continuing with method 400, the case stage is updated at 420. Each stage can have a status of inactive, active, paused and completed, for example and stored as part of status data 220. The inactive status typically implies that the stage has not yet been reached. The active status typically implies that the stage is being worked on. The paused status implies that the stage was activated, but it is now on hold, until for example, an external event such as actuary work is completed. The completed status typically implies that the stage has been completed. Similar statuses can also be applied to workflow steps.

The determination of a stage's status is typically based on the data received for that stage. For example, to complete a stage, typically data entry and actions associated with stage must be completed as well as any actions such as sending communications, phone calls, filing documents with courts or other regulatory bodies, drafting documents, filling forms and others that will now occur to a person of skill in the art. To pause a stage, an indication of an action is taken that requires other stages or parts of stages, such as a separate paused stage that tracks the actions that caused the pause, to be completed. For example, in the present example, it'll be assumed that the data entry for accidents/injuries, benefits claims, and the key documents, where key documents are entered into the system, are completed. Accordingly, the status of the stage is updated to completed, and the current stage of the case is updated to Date Proposed. The status data 220 for that case is then updated in data-store 124. In variations, the account responsible for performing the next stage or next step of the workflow can be notified through emails, and other means of notification, including indicators in the dashboard 500.

In some implementations, the data received at different stages can be the basis of the determination of which specific account to associate with a case. Advantageously, account association based on case data can lead to more efficient allocation of resources including case data and improved case processing. For example, the Accidents/Injury data received from the sub data entry area of interface 300 can serve as the basis for determining the lawyer for that case. In one implementation, the data received for Accidents/Injury can be used for determining an injury rank. The injury rank can be based on type of injury identified in data entry area 304, such as bodily injury or psychological problems, the seriousness of the injury such as whiplash, severed arm, severe brain injury and others that will now occur to a person of skill in the art. The injury can thus be categorized and also sub-categorized to identify further details. Based on the injury rank, an account can be identified and associated with the case as a case manager. For example, a case involving serious injuries can be matched with lawyer accounts with the classification criteria of senior. On the other hand, a case involving superficial injuries can be associated with a junior lawyer account. It will now occur to a person of skill in the art that there are many other factors that can be used in identifying accounts to assign to a case. For example, additional factors that can be obtained from the case data and used for identifying appropriate accounts include the claim amounts, subject matter, complexity, the opposing side managers, client, and to others that will now occur to a person of skill in the art. Account data can also include additional classifications or categories on which the determination can be based. These include, for example, workload, performance, seniority, subject matter expertise and others that will now occur to a person of skill in the art. Moreover, if there is more than one potential account for association, the selection of one of those accounts can be based on a ranking. The ranking can be a simple queue where the accounts are queued, and the first available one chosen. The rankings can also be based on criteria such as relative performance, workload and expertise of the identified accounts. A person of skill in the art will now be able to identify other basis of ranking accounts.

Determination of which specific account to assign to a case can occur at any stage. For example, when a case is first initiated, an assistant account can be assigned out of a queue where the ranking is based on next available account. After the account is opened, a clerk account can be assigned to identify the issues and fill out the associated data, and enter the relevant documents into the system. The identification of the clerk can be based on expertise and availability. Once the issues are identified, a lawyer account can be assigned to review the issues data and to initiate settlement proceedings. At this stage, an additional assistant can be assigned on the basis of being the lawyer's paired assistant, indicating that this stage can be operated on by two accounts simultaneously. The assigned assistant can assist with the tasks of sending appropriate communications to the appropriate parties for the settlement proceedings and client instructions as well as populating the calendar programs associated with the case to reflect appropriate settlement meetings. In one variation, each account's functions can be delineated on the bases of workflow steps for that stage. The communications can be automatically generated on the basis of the case data 204. Other arrangement of stages, workflows and account assignment will now occur to a person of skill in the art.

Accounts assigned to a case can be notified through various means. The case can now appear in their dashboard with an indicator indicating the case to be newly assigned. Alternatively a message or other notification can be automatically generated and forwarded to that account. Other methods of notifying a newly assigned account will now occur to a person of skill in the art.

Although the example implementations have provided some examples based on accident benefit cases, system 100 and method 400 are applicable to the management of other types of legal case types. For example, the system can be applied to tort cases, and other civil litigation cases. Other types of applicable legal cases will now occur to a person of skill in the art. Moreover, the system can be customized for different jurisdictions such as different states and countries to reflect requirements that are unique to those jurisdictions. In variations, at least portions of the case data can be imported or synchronized with traditional legal docketing systems.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A computing device for legal project management comprising:
a datastore configured for:
storing a plurality of accounts; and
storing case data for a case including a current stage and a first association to a first account of the plurality of accounts, the first account being associated with the current stage; and
a processor configured for:
retrieving the current stage and the first account;
receiving data associated with the current stage wherein the data is provided by the first account.

2. The computing device of claim lwherein the processor is further configured for:
determining a next stage based on the entered data and the case data; and
determining a second account of the plurality of accounts based on the additional data and the case data, the second account being associated with the next stage.

3. The computing device of claim 2 wherein thedeterminig of a second account further comprises:
determining a ranking of the case based on the additional data;
determining a categorization of the second account; and
associating the second account with the case data based on said ranking and categorization.

4. The computing device of claim 1, the computing device further comprising a network interface, the processor further configured for:
sending an indication the data entry area for display at a client terminal based on the current stage wherein the data entry area is for operation by the first account.

5. The computing device of claim 1 wherein the processor is further configured for:
determining a workflow associated with the stage;
providing a an indication of a status bar indicating the current stage; and
providing an indication of a second status bar indicating the workflow.

6. A method for legal project management, performed on a computing device, the method comprising:
maintaining a plurality of accounts
maintaining case data for a case including a current stage and a first association to a first account of the plurality of accounts, the first account being associated with the current stage;
providing a data entry area based on the current stage wherein the data entry area is for operation by the first account.

7. The method of claim 6 further comprising:
receiving additional data;
determining a next stage based on the additional data and the case data; and
determining a second account of the plurality of accounts based on the additional data and the case data.

8. The method of claim 7 wherein the determining a second account further comprises:
determining a ranking of the case based on the additional data;
determining a categorization of the second account; and
associating the second account with the case data based on said ranking and categorization.

9. The method of claim 6 wherein the providing further comprises:
determining a workflow associated with the stage; and
updating the data entry are and the first account based on the workflow.

10. The method of claim 7 further comprising:
providing a second data entry area based on the next stage wherein the second data entry area is for operation by the second account.

11. The method of claim 6 wherein the case data includes a second association with a second account, and the data entry area is additionally for operation by the second account.

12. The method of claim 6 the providing further comprising:
providing a status bar indicating the current stage; and
providing an indication of the entry area associated with the current stage.

13. The method of claim 12 further comprising:
providing a plurality of selectors for selecting data entry areas; and
indicating at least one of the selectors as an indication of the entry area associated with the current stage.

14. The method of claim 8 wherein the case ranking is an indication of one of injury, claim amount, subject matter and complexity.

15. The method of claim 8 wherein the account categorization is an indication of one of workload, availability, performance, seniority and subject matter expertise.

16. The method of claim 6 further comprising:
maintaining meta-data for tracking the current stage based on case data.

17. The method of claim 6 further comprising:
maintaing meta-data for tracking the first account based on the case data.

18. The method of claim 6 wherein case data includes instructions data having criteria, the method further comprising:
performing a task based on the instructions data is the task satisfies the instructions data criteria.
